(19) United States
(12) Patent Application Publication
(10) Pub. No.: US 2006/0075103 A1
(43) Pub. Date: Apr. 6, 2006

(54) Systems, methods, and media for providing access to clients on a network

(75) Inventors: Daryl Carvis Cromer, Apex, NC (US); Mark Charles Davis, Durham, NC (US); Howard Jeffrey Locker, Cary, NC (US); Randall Scott Springfield, Chapel Hill, NC (US)

Correspondence Address: LENOVO (SINAPORE) PTE. LTD. (RTP);c/o SCHUBERT OSTERRIEDER & NICKELSON PLLC, 6013 CANNON MTN. DR., S14, AUSTIN, TX, 78749, US

(73) Assignee: International Business Machines Corporation, Armonk, NY (US)

(21) Appl. No.: 10/958,573

(22) Filed: Oct. 5, 2004

(51) Int. Cl. G06F 15/173

(52) U.S. Cl. 709/225

(57) ABSTRACT

Systems, methods and media for providing access to a network are disclosed. More particularly, hardware and/or software for providing network access only to client computer systems with acceptable status information are disclosed. Embodiments include a method that generally includes receiving a request for a network address from a client computer system via a network and determining whether the status of the requesting client computer system is acceptable. In the event that the status of the client computer system is determined to be acceptable, the method also generally includes assigning and transmitting a network address to the client computer system. In some embodiments, the status of the client computer system may include information about the system configuration, installed software, presence of files such as virus files, etc.

### FIELD OF INVENTION

The present invention is in the field of computer systems. More particularly, the present invention relates to systems, methods and media for providing network access to clients based on the status of the clients.

### BACKGROUND

Personal computer (PC) systems are well known in the art. They have attained widespread use in many segments of today's modern society as a result of their widespread use for telecommuting, news, stock market information and trading, banking, shopping, shipping, communication in the form of hypertext transfer protocol (http) and email, as well as other services. With PCs being increasingly connected into networks to allow transfers of data among computers to occur, more operations such as maintenance, updating of applications, workplace collaboration, and data collection are occurring over networks, increasing data traffic over the networks.

As a result of their significant utility, the number of PCs connected to networks continues to increase, creating enormous demands on networks with respect to bandwidth, security, and efficiency. For example, many businesses use a network such as a corporate intranet or Local Area Network (LAN) to connect PCs or other computer systems of their employees. Such networks facilitate collaboration and seamless sharing of information. As businesses or other enterprises acquire more and more computers, and use them in an increasingly varied number of ways, it becomes more difficult to maintain all of the computers because of their diversity and complexity. Moreover, the consequences of failing to properly maintain the computers, particularly the software on the computers, have increased in severity. Failing to ensure that each computer has the latest virus protection, for example, may jeopardize the entire network and its data in the event that a virus is unleashed upon the network through an unprotected computer.

In a less severe case, communication between users utilizing different versions of the same computer program can result in confusion and loss of efficiency. Differences in operating systems among different client computers, in one example, may cause difficulty for administrators in applying updates. Differences in word processing programs, as another example, may lead to inefficiencies in converting electronic documents, lost time, etc.

Yet another difficulty with maintaining a large network of clients is ensuring that the software on each computer is properly licensed. An organization is typically charged for each client that is using a particular piece of software. Failure to properly monitor the status of the software on each client may lead to legal liability in the event that users place unauthorized software on their computer or when licenses are not properly maintained.

These and other problems may occur when trying to maintain multiple computers on a network. Administrators usually attempt to keep each client computer at the most recent state so as to avoid these problems. Such efforts, however, can be time-consuming, expensive, and prone to omission of some clients. Some organizations rely on users to update their own software, e.g., in response to reminders from the administrator. Such a system is flawed, however, as many users will not perform the necessary steps to properly maintain and update their computer systems.

Other organizations rely on automated routines to search all client computer systems to determine the status of the software on each. If a computer system needs an update, an administrator may then update that system or send a warning to the user that their system is not in compliance. This method, however, relies on searching clients that are already on the network. While there is an advantage to identify non-compliant clients so that they may then be brought into compliance, such methods are still flawed. First, many client computers may not be on the network when the search is done, such as notebook computers that are not logged in, computers off-line that are being fixed, etc. Moreover, such a system requires a proactive search and does not provide protection during timeframes between searches. In addition, if a non-compliant computer even gets on the network, the damage may already be done. For example, if a client is infected with a virus because its virus file is out of date and gets one on the network, the virus can still inflict damage on that client, other clients, or the network.

There is, therefore, a need for an effective and efficient system to provide access to clients on a network. There is an even greater need for such a system when clients may go on and off the network at various times.

### SUMMARY OF THE INVENTION

The problems identified above are in large part addressed by systems, methods and media for providing access to client computer systems on a network. One embodiment provides a method for providing network access that generally includes receiving a request for a network address from a client computer system via the network. The method also generally includes determining the status of the requesting client computer system and determining whether the status of the requesting client computer system is acceptable. In the event that the status is determined to be acceptable, the method also may include assigning a network address to the requesting client computer system and transmitting the assigned network address to the requesting client computer system. In some embodiments, the network address may be an Internet Protocol (IP) address and the network may be a LAN, intranet, wireless network, etc. The status of the requesting client computer system may include an indication of software installed on the requesting client computer system, an indication of a virus file located on the requesting client computer system, etc.

In some embodiments, the method may further include an embodiment where determining the status of the requesting client computer system includes querying a database to determine the system configuration of the requesting client computer system. In this embodiment, the request for a network address may include an indication of the identity of the requesting client computer system. In other embodiments, the request for a network address may include an indication of software installed on the requesting client computer system, an indication of a virus file located on the requesting client computer system, etc.

Another embodiment provides a machine-accessible medium containing instructions effective, when executing in a data processing system, to cause the system to perform a series of operations for providing access to a network. The series of operations generally includes receiving a request for a network address from a client computer system via the network. The series of operations also generally includes determining the status of the requesting client computer system and determining whether the status of the requesting client computer system is acceptable. In the event that the status is determined to be acceptable, the series of operations also may include assigning a network address to the requesting client computer system and transmitting the assigned network address to the requesting client computer system. In some embodiments, the network address may be an Internet Protocol (IP) address and the network may be a LAN, intranet, wireless network, etc. The status of the requesting client computer system may include an indication of software installed on the requesting client computer system, an indication of a virus file located on the requesting client computer system, etc.

A further embodiment provides an apparatus for providing access to one or more client computer systems to a network. The system may include a communications module to receive a request message from a client computer system via the network and to transmit a network address to the client computer system via the network. The system also generally includes a status determining module for determining the status of the client computer system and determining whether the status of the client computer system is acceptable. If the status is acceptable, a network address module may select a network address for the client computer system, which may then be transmitted to the client computer system by the communications module. A further embodiment includes an update module for updating the client computer system via the network if the status determining module determines that the status of the client computer system is unacceptable.

### BRIEF DESCRIPTION OF THE DRAWINGS

Other objects and advantages of the invention will become apparent upon reading the following detailed description and upon reference to the accompanying drawings in which, like references may indicate similar elements:

FIG. 1 depicts an environment for a system for providing access to clients on a network according to one embodiment;

FIG. 2 depicts an exploded perspective view of certain elements of a processing device, including a chassis, a cover, and a planar board;

FIG. 3 depicts a block diagram of certain components of the processing device of FIG. 2;

FIG. 4 depicts one embodiment of the network address server of FIG. 1;

FIG. 5 depicts an example of a flow chart for receiving a request for a network address and selectively providing a network address according to one embodiment;

FIG. 6 depicts an example of a flow chart for a client computer system to gain access to network according to one embodiment; and

FIG. 7 depicts an example of a flow chart for receiving a request for a network address and selectively providing a network address according to another embodiment.

### DETAILED DESCRIPTION OF EMBODIMENTS

The following is a detailed description of example embodiments of the invention depicted in the accompanying drawings. The example embodiments are in such detail as to clearly communicate the invention. However, the amount of detail offered is not intended to limit the anticipated variations of embodiments; but, on the contrary, the intention is to cover all modifications, equivalents, and alternatives falling within the spirit and scope of the present invention as defined by the appended claims. The detailed descriptions below are designed to make such embodiments obvious to a person of ordinary skill in the art.

Systems, methods and media for providing access to a network are disclosed. More particularly, hardware and/or software for providing network access only to client computer systems with acceptable status information are disclosed. Embodiments include a method that generally includes receiving a request for a network address from a client computer system via a network and determining whether the status of the requesting client computer system is acceptable. In the event that the status of the client computer system is determined to be acceptable, the method also generally includes assigning and transmitting a network address to the client computer system. In some embodiments, the status of the client computer system may include information about the system configuration, installed software, presence of files such as virus files, etc.

The disclosed embodiments provide an effective and efficient system of controlling access to the network and for updating client computer systems by, in some embodiments, only granting network addresses (and thus access to the network) to client computer systems for which the status is determined to be acceptable. This provides a way of helping to ensure that client computer systems on the network have an acceptable status (i.e., are fully updated). In one example, only client computer systems with the latest version of their operating system may be allowed access. The disclosed embodiments may also help encourage users to update their computer systems or, in some embodiments, provide updates to the client computer systems. These embodiments may assist in protecting the network from client computer systems with outdated versions of software, protecting other clients from viruses or other types of attacks, etc.

While specific embodiments will be described below with reference to particular configurations of hardware and/or software, those of skill in the art will realize that embodiments of the present invention may advantageously be implemented with other substantially equivalent hardware and/or software systems.

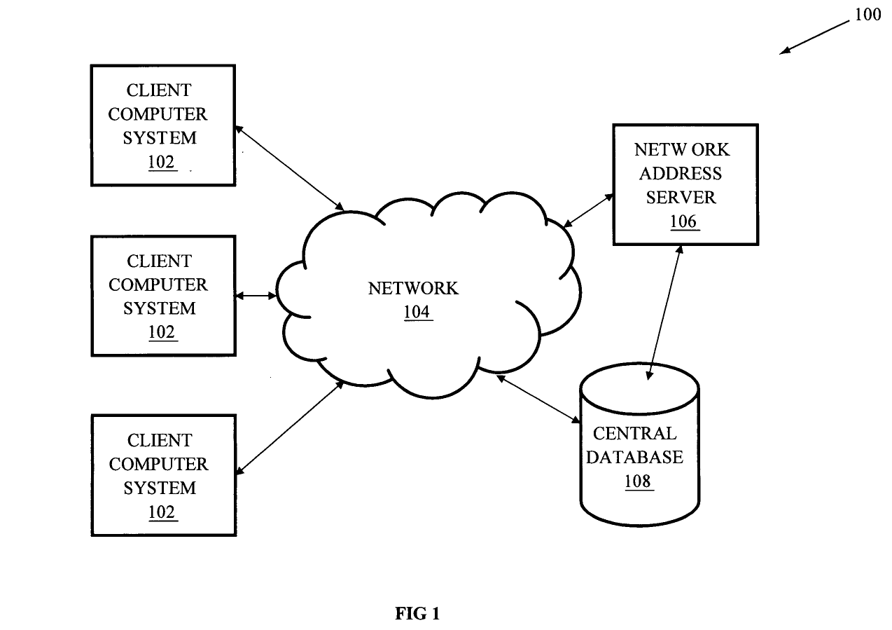

Turning now to the drawings, FIG. 1 depicts a network access system 100 for providing access to clients on a network 104 according to one embodiment. In the depicted embodiment, network access system 100 includes a plurality of client computer systems 102 in communication with network 104. Network access system 100 also includes a network address server 106 in communication with network 104 in the depicted embodiment. The network address server 106 may selectively provide network addresses to client computer systems 102. In one embodiment, at least some of the client computer systems 102 are remote from the network address server 106.

Network access system 100 also includes a central database 108 for storing information about the client computer systems 102, and the central database 108 may be in communication with the network address server 106 and/or the network 104. In network access system 100, the client computer systems 102, network address server 106, and central database 108 may be located at the same location, such as in the same building or computer lab, or could be remote. While the term “remote” is used with reference to the distance between the components of network access system 100, the term is used in the sense of indicating separation of some sort, rather than in the sense of indicating a large physical distance between the systems. For example, any of the components of network access system 100 may be physically adjacent or located as part of the same computer system in some network arrangements.

Network 104 may be any type of data communications channel, such as the Internet, an intranet, a LAN, a wide area network (WAN), an Ethernet network, a wireless network, etc. In a corporate or enterprise environment, network 104 may be a LAN, which may be located behind a firewall or other network security measure. Those skilled in the art will recognize, however, that the invention described herein may be implemented utilizing any type of data communications channel.

Client computer systems 102 may include any type of processing device that attempts to gain access to network 104. Client computer systems 102 may include one or more PCs, workstations, servers, mainframe computers, notebook or laptop computers, tablet PCs, desktop computers, portable computer system, personal digital assistants (PDAs), set-top boxes, mobile phones, wireless devices, or the like. In one embodiment, client computer systems 102 used in a corporate environment may be desktop or notebook computers used by employees of the corporation. In another embodiment, client computer devices 102 are wireless devices such as PDAs or phones that are used to attempt to access a wireless network 104. Users may use client computer systems 102 to attempt to access network 104, and client computer systems 102 that are on network 104 may be considered clients of network 104.

Network address server 106 may include any type of processing device that provides network addresses to client computer systems 102 attempting to access network 104. Network address server 106 may include one or more PCs, workstations, servers, mainframe computers, notebook or laptop computers, tablet PCs, desktop computers, portable computer system, PDAs, set-top boxes, mobile phones, wireless devices, or the like. In one embodiment, network address server 106 may be a Dynamic Host Configuration Protocol (DHCP) server that assigns network addresses, such as Internet Protocol (IP) addresses, to clients on the network 104, such as client computer systems 102. DHCP servers typically provide clients with a dynamically assigned IP address upon request or connection to the network. In the disclosed embodiments, the network address server 106 may only provide network addresses to client computer systems 102 that meet certain qualifications in terms of their configuration, such as loaded software versions, etc.

Network access system 100 may also include a central database 108 for sharing information relating to the network access system 100, such as client computer system 102 configuration information. Central database 108 may be a relational database, and may use any sort of software, such as MySQL. Central database 108 may be located anywhere within network access system 100, including as a standalone database, as part of the network address server 106, etc., and may be stored on any type of storage device, such as hard drives, server farms, volatile memory, etc.

In network access system 100, one or more client computer systems 102 may attempt to gain access to network 104. A client computer system 102 attempting to gain access to network 104 may, in one embodiment, send a request message via network 104 to the network address server 106. The network address server 106 may determine the status of the requesting client computer system 102 and whether the status of the client computer system 102 is acceptable. If the status of the client computer system 102 is acceptable, the network address server 106 may then, in some embodiments, assign and transmit a network address to the requesting client computer system 102. The client computer system 102 may then use that network address to access the network 104. If the status of the client computer system 102 is unacceptable, the network address server 106 may refrain from assigning a network address, preventing the unacceptable client computer system 102 from gaining access to the network 104. Access to the network 104 is therefore limited, in some embodiments, to client computer systems 102 with acceptable statuses on a case-by-case basis as each client computer system 102 attempts to access the network 104.

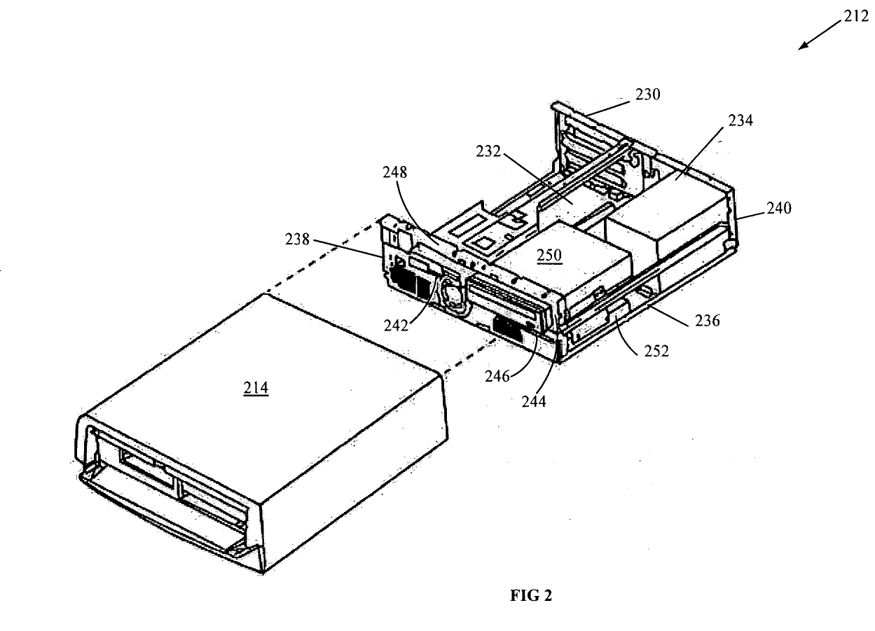

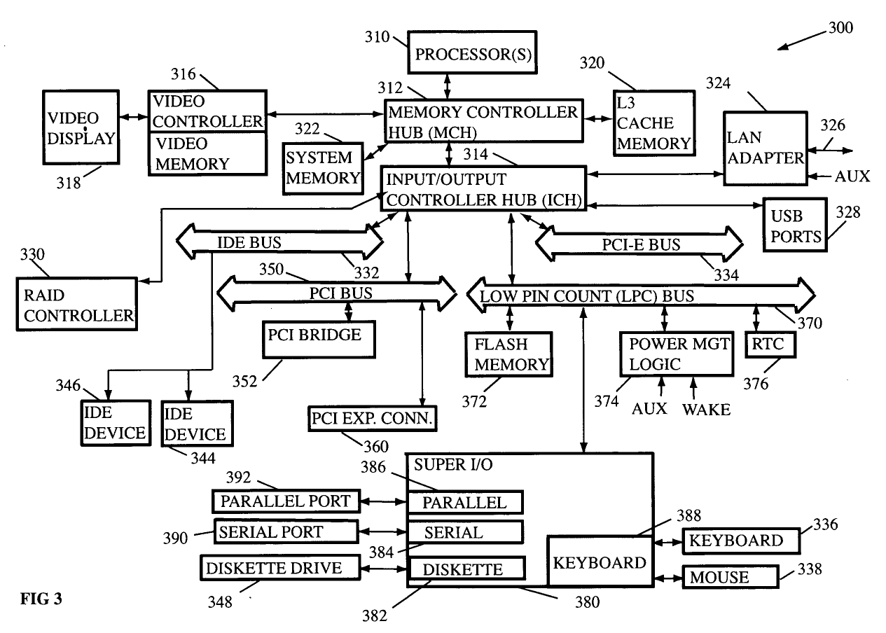

FIGS. 2 and 3 depict one embodiment of a personal computer 212 suitable for use as, for example, a client computer system 102 or a network address server 106. Other possibilities for the personal computer 212, client computer system 102, or network address server 106 are possible, including a computer having capabilities other than those ascribed herein to a “personal computer”, and possibly beyond those capabilities, and they may, in other embodiments, be any combination of processing devices such as workstations, servers, mainframe computers, notebook or laptop computers, desktop computers, PDAs, wireless devices, mobile phones, or the like.

FIG. 2 depicts an exploded perspective view of certain elements of a personal computer 212 according to one embodiment, including a chassis 230, a cover 214, and a planar board 232. Cover 214 is a decorative outer member that cooperates with a chassis 230 in defining an enclosed, shielded interior volume for receiving electrically powered data processing and storage components to process and store digital data. At least certain of these components may be mounted on a multi-layer planar 232 or motherboard which may be mounted on the chassis 230 and may provide a means for electrically interconnecting the components of the personal computer 212, including those identified above and such other associated elements as floppy disk drives, various forms of direct access storage devices, accessory adapter cards or boards, and the like.

Personal computer 212 may have a power supply 234 that may be actuated by a power switch (not shown). The chassis 230 may have a base indicated at 236, a front panel indicated at 238, and a rear panel indicated at 240. The front panel 238 may define at least one open bay for receiving a data storage device such as a disk drive for magnetic or optical disks, a tape backup drive, or the like.

In the illustrated form, a pair of upper bays 242, 244 and a lower bay 246 are provided. One of the upper bays 242 may be adapted to receive peripheral drives of a first size (such as those known as 3.5 inch drives) while the other 244 may be adapted to receive drives of a different size (such as a CD-ROM or DVD-ROM drive) while the lower bay may be adapted to receive another drive. One floppy disk drive indicated at 248 may be a removable medium direct access storage device (DASD) capable of receiving a diskette inserted there into and using the diskette to receive, store and deliver data as is generally known. One CD-ROM drive indicated at 250 is a removable medium DASD capable of receiving a compact disk inserted there into and using the disc to deliver data as is generally known. One hard disk drive is indicated at 252 and is a fixed medium DASD capable of storing and delivering data as is generally known.

Referring now to FIG. 3, there is shown a block diagram 300 of certain components of the personal computer 212 of FIG. 2. The components of FIG. 3 comprise components mounted on the planar 232 or other hardware of the personal computer 212. Connected to the planar 232 is the system CPUs or processor(s) 310, which may be connected directly to a memory controller hub (MCH) 312. As one example, the system processor(s) 310 could be an Intel Pentium processor, Cyrix 586-P75 processor or Advanced Micro Devices 8486 processor or any other suitable processor.

MCH 312 and input-output (I/O) controller hub (ICH) 314 represent part of the personal computer's 212 core logic chipset, facilitating access to/from processor(s) 310 from/to memory devices and I/O devices, respectively. More specifically, MCH 312 may provide access to system memory 322 and level three (L3) cache memory 320. In many such embodiments, level one (L1) and level two (L2) cache are incorporated into each processor of processor(s) 310. MCH 312 may also include a special bus adapted for direct memory access (DMA) by a video controller. In some embodiments, the special bus may be an accelerated graphics port (AGP). The AGP may be a high-speed port that is designed for the display adapter 316, a video card typically including a video controller and video memory. The AGP may provide a direct connection between the card 316 and system memory 322. In other embodiments, a peripheral component interconnect (PCI) bus such as a PCI-E bus may be implemented for video display 318.

System memory 322 may include random access memory (RAM) such as double data rate (DDR) synchronous dynamic random access memory (SDRAM). System memory 322 may be composed of one or more memory modules and MCH 312 may include a memory controller with logic for mapping addresses to and from processor(s) 310 to particular areas of system memory 322 and a cache controller operatively coupled with L3 cache memory 320.

Input/Output Controller Hub (ICH) 314 may be designed to coordinate communications with various I/O devices. In the depicted embodiment, ICH 314 couples with local area network (LAN) adapter 324, universal serial bus (USB) ports 328, redundant array of independent disks (RAID) controller 330, integrated drive electronics (IDE) bus 332, PCI Express (PCI-E) bus 334, PCI bus 350, and low pin count (LPC) bus 370. LAN adapter 324 may be coupled to either the PCI bus 350 or directly to ICH 314 to facilitate communication (i.e., transmit/receive data) with a remote computer or server over a LAN via a connection or link 326. LAN adapter 324 may be a card to be plugged in personal computer 212 or a LAN connection embedded on the planar 232. LAN adapter 324 may also be known as a network interface card (NIC). LAN adapter 324 may be utilized by either client computer systems 102 or the network address server 106 to assist in sending or receiving messages via a LAN network in some embodiments.

LAN adapter 324 may include a Media Access Controller (MAC), which serves as an interface between a shared data path (e.g., a media independent interface as described below) and the ICH 314. The MAC may perform a number of functions involved in the transmission and reception of data packets. For example, during the transmission of data, the MAC assembles the data to be transmitted into a packet with address and error detection fields. Conversely, during the reception of a packet, the MAC disassembles the packet and performs address checking and error detection. In addition, the MAC typically performs encoding/decoding of digital signals transmitted over the shared path and performs preamble generation/removal as well as bit transmission/reception. The MAC may be, for example, an Intel 82557 chip.

LAN adapter 324 may further comprise a physical layer and a media independent interface (MII), which is a local bus between the MAC and the physical layer. The MII is a specification of signals and protocols, which formalizes the interfacing of a 10/100/1000 Mbps Ethernet MAC, for example, to the underlying physical layer. The physical layer receives parallel data from the MII local bus and converts it to serial data for transmission over link 326. The physical layer may be, for example, an Integrated Circuits Systems 1890 chip. The physical layer includes auto-negotiation logic that, in one embodiment, determines the capabilities of a server, advertises its own capabilities to the server, and establishes a connection with the server using the highest performance common connection technology.

Personal computer 212 may include one or more USB ports 328, which are hardware interfaces for peripherals such as the keyboard, mouse, joystick, scanner, printer, telephony devices, hard drives, compact disk (CD) drives, digital video disk (DVD) drives, and the like. Personal computer 212 may include a RAID controller 330, which is a controller for a disk subsystem that is used to increase performance or provide fault tolerance. More specifically, RAID controller 330 may couple with a set of two or more ordinary hard disks and improves performance by disk striping, which interleaves bytes or groups of bytes across multiple drives, so more than one disk is reading and writing simultaneously.

IDE bus 332 and PCI-E bus 334 may be incorporated to facilitate connection of additional I/O devices with ICH 314. IDE bus 332 is a type of hardware interface widely used to connect hard disks, CD-ROMs and tape drives to a PC. IDE bus 332 provides for the attachment for hard disk drive 344 and CD-ROM drive 346. PCI-E bus 334 is a high-speed peripheral interconnect designed to match the higher speeds of CPUs. PCI bus 350 may couple a PCI bridge 352 to facilitate the connection of additional PCI devices and a PCI expansion connector 360 to facilitate expansion of the PCI bus 350 so even more peripheral devices can communicate with ICH 314 via PCI bus compatible peripheral cards.

Attached to the LPC 370 may be a flash memory (FM) module or chip 372, power management logic 374, and a real-time clock (RTC) 376, and a multi-function or super I/O controller 380. Flash memory module 372 contains microcode that personal computer 212 will execute on power on. The flash memory 372 may be a non-volatile memory module or chip. Power management logic 374 allows for changing between various power states (e.g., off, suspend and normal operating states). The circuitry is supplied with auxiliary power (AUX), or standby power, from the power supply 234 (as shown in FIG. 2) when the personal computer 212 is in the off state so that it can monitor events that cause the personal computer 212 to turn on.

The real-time clock (RTC) 376 may be used for time of day calculations. Super I/O controller 380 may include functionality such as, for example, a National Semiconductor PC87307. The super I/O controller 380 may contain a variety of I/O adapters and other components such as the diskette adapter 382, serial adapter 384, a parallel adapter 386 and keyboard controller 388. The diskette adapter 382 provides the interface to the diskette drive 348. The serial adapter 384 has an external port connector, serial port 390, for attachment of external devices such as modems (not shown). The parallel adapter 386 has an external port connector, parallel port 392, for attachment of external devices such as printers (not shown). The keyboard controller 388 is the interface for the connectors, keyboard 336 and mouse 338.

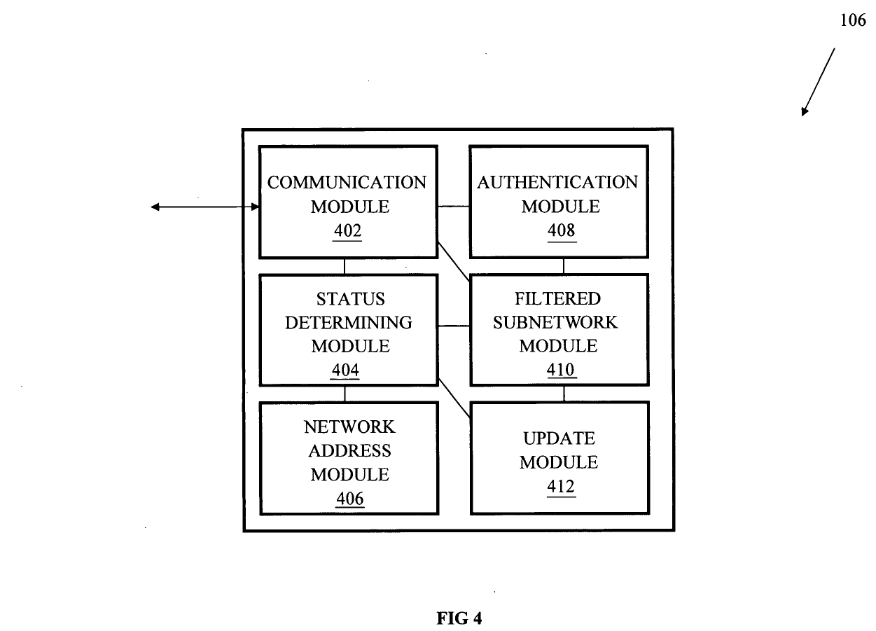

FIG. 4 depicts one embodiment of the network address server 106 of FIG. 1. In the depicted embodiment, the network address server 106 includes a communications module 402, a status determining module 404, a network address module 406, an authentication module 408, a filtered subnetwork module 410, and an update module 412. The communication module 402 may be used to transmit and receive communications from the client computer systems 102, such as via the network 104. In one embodiment, the LAN adapter 324 may be utilized to perform some or all of the functions of the communications module 402.

The status determining module 404 may be used to determine the status of a client computer system 102 from which a request for network access was received by the communication module 402. In one embodiment, information about the status of a client computer system 102 may be included within the request for network access (i.e., the request message). For example, the request for network access may include information about which version of the operating system is running on a client computer system 102, which version of particular programs are on the client computer system 102, which security patches have been installed, etc. In this embodiment, the status information about the client computer system 102 would be analyzed in order to determine whether the current status is acceptable. If the version of the operating system, for example, was outdated and did not have the most recent patch, the status determining module 404 may determine that network access should be denied as the outdated operating system version is a threat to the entire network. Similarly, if the client computer system 102 had software which was not properly licensed access could also be denied and the status of the client computer system 102 deemed unacceptable. In this embodiment, the status of the client computer system 102 may be compared to a minimum or other standard that may be stored locally, at a central database 108, etc.

In order to determine whether a status is acceptable, the status may be compared to a standard or other set of requirements. In one embodiment, an administrator may set certain requirements for computer systems to be acceptable (e.g., this type of operating system must be at version 2.01 or later, this other type must be at version 6.2 or later, etc.). In another embodiment, the tested criteria must be at the most recent version. In another embodiment, the presence or lack of a certain file determines whether or not the client computer system 102 is acceptable. Any type of methodology may be used to determine whether a client computer system 102 is acceptable.

In another example of this embodiment, the DHCP protocol may be modified to include status information about the client computer system 102 in the DHCP message requesting access to the network. A DHCP message typically contains a plurality of fields, including both fixed format fields and a variable length option field. These fields may contain an identification of the client computer system 102, of the network address server 106, a transaction number, etc. In one embodiment, client status information may be stored in one of the existing DHCP fields, such as the ‘option’ field, but the DHCP message protocol may also be modified to include different or additional fields for the status information.

In an alternative embodiment, the status determining module 404 may receive an identification of the client computer system 102 and look up the status of that system from another source. For example, an identification of the client computer system 102 may be included in the request message (e.g., the DHCP message), such as an Universal Unique Identifier (UUID), a client hardware address in DHCP (e.g., ‘chaddr’ field), a serial number, etc. The status determining module 404 may then query a database based on the identification of the client computer system 102 to determine its status. In this embodiment, a database or centralized knowledge repository such as central database 108 may be used to store information relating to the status of a group of client computer systems 102. This database may be populated by inventory programs that scans clients on a network to determine software versions, bases status on installation or shipping records for the clients, etc. International Business Machine's (IBM's) Asset Depot is one program that may be used to gather status information (i.e., software versions, etc.) from a group of client computer systems 102 and store the status information in a centralized database, where it may be accessed by the status determining module 404. For example, an organization may use a centralized database 108 to store information about each user's client computer system 102 so that it may be readily accessed based on the identity of the client computer system 102.

The network address server 106 may also include a network address module 406. The network address module 406 allocates network addresses, such as IP addresses, to authorized client computer systems 106. The network address module 406 may, in one embodiment, only assign a network address when the client computer system 102 is approved by the status determining module 404. The network addresses may be allocated in any way, such as dynamically, out of a database of available network addresses, manually by an administrator, sequentially, etc. In an alternative embodiment, the network address module 406 may assign network addresses associated with a subnetwork having lesser capabilities than network 104.

The network address server may also include an authentication module 408, which is an optional module that may be used to authenticate client computer systems 102, such as by requiring a password for network access. Optional filtered subnetwork module 410 and update module 412 may be used in an alternative embodiment where a filtered subnetwork is used for some client computer systems 102 that are not fully up to date. The filtered subnetwork may be used to provide a subnetwork to client computer systems 102 based on their access level. This alternative embodiment may be particularly useful in situations where a client computer system 102 may be easily updated to the desired status. Filtered subnetwork module 410 may be used to establish and/or control the subnetwork that is optionally created. The update module 412 may be used in this embodiment to update the software, virus files, etc., of the client computer system 102 so that the system meets the requirements of network 104. The connection of the subnetwork may be used to update the software or other files, but access to the broader network 104 may be denied to protect network 104 and other client computer systems 102.

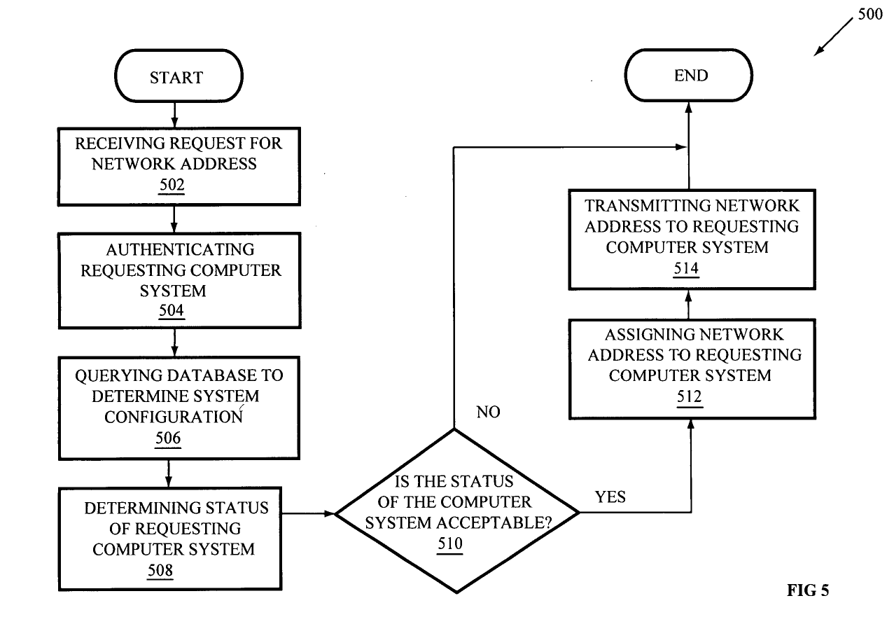

FIG. 5 depicts an example of a flow chart 500 for receiving a request for a network address and selectively providing a network address according to one embodiment. The method of flow chart 500 may be performed, in one embodiment, by the network address server 106. Flow chart 500 begins with element 502, receiving a request for a network address. In this element, a request for a network address is received via network 104, such as from a client computer system 102. In some embodiments, the request for a network address includes an indication of the identity of the requesting client computer system 102. In one embodiment, the request for a network address may be in the format of a DHCP message. Other formats are also possible, including formats associated with other types of networks, including wireless networks.

In optional element 504, the requesting client computer system 102 may be authenticated. In one embodiment, authentication requires verification of a password offered by the client computer system 102. Authentication may be used to ensure that only authorized users (and not just authorized client computer systems 102) access network 104.

In optional element 506, a database may be queried to determine the configuration of the requesting client computer system 102. Element 506 may be used in situations where information about the status of the client computer system 102 is not included in the request message, such as when the request message only includes an identification of the requesting client computer system 102. The standard DHCP protocol, for example, would typically not include information about software versions or other status information, making element 506 more useful. In element 506, a database (such as central database 108) may be queried by looking up status information that may be stored by client computer system 102. For example, central database 108 may contain the latest recorded versions of all software and virus files for each client computer system 102 that accesses network 104. The central database 108 may be populated based on automated searches that are run over network 104 or any other method. By having an indication of the identity of the requesting client computer system 102, element 506 may be utilized to access status information for the requesting client computer system 102 without having to include status information within the request message (and thus without having to modify existing formats).

Flow chart 500 continues to element 508, determining the status of the requesting computer system 102. In an embodiment where a database is queried in element 506, element 508 may involve comparing the status of the requesting client computer system 102 with a desired status. For example, versions later than version 2.0 may be considered acceptable, while earlier versions are considered unacceptable. In another example, element 508 may determine if the software on the requesting client computers system 102 is licensed by review of records in the database queried in element 506. Any type of determination is possible to determine whether the status of the requesting client computer system 102 is acceptable.

In an embodiment without element 506, element 508 may include analyzing information contained within the request message to determine the status of the requesting computer system 102. In this embodiment, the request message contains an indication of the status of the client computer system 102, such as the software programs, versions, last update dates, etc. contained on the client computer system 102. By analyzing the request message, the status of the software or other items relating to the client computer system 102 may be easily determined. In one example, the request message may contain the version number of the installed operating system and a date for the virus file used by a virus protection program. Any type of information (e.g., software versions, dates, virus file information, software license information, etc.) may be utilized.

Flow chart 500 continues to decision block 510, where it is determined whether the status determined in element 508 is acceptable for access to network 104. In one embodiment, the status of the requesting client computer system 102 is compared to minimum requirements for different aspects of the computer system, such as software versions. In the example outlined in element 508 with status including operating system and virus file version, if it is determined in decision block 510 that either the installed operating system or the virus file are out of date the status may be considered unacceptable. Similarly, if both the installed operating system and virus file are up to date, the status of the client computer system 102 may be considered to be acceptable. Any type of measure of that information (e.g., comparison to a certain date or version, validity of the license, date of update, etc.) may be utilized. If the status is determined to be unacceptable, flow chart 500 simply terminates. In this situation, the requesting client computer system 102 would not be granted a network address, preventing it from fully accessing network 104. This provides a simple and effective way of preventing unacceptable client computer systems 102 from accessing (and possible damaging) network 104.

If it is determined that the status of the client computer system 102 is acceptable in decision block 510, flow chart 500 continues to element 512, assigning network address to the requesting computer system 102. In this element, a network address (typically a unique network address) may be assigned to the client computer system 102 so that it will have access to network 104. The network address may be assigned in any fashion, such as randomly, sequentially, by static or dynamic assignment, etc. For an IP network utilizing DHCP, a pool of network addresses (IP addresses) may be maintained and an address may be leased to an approved client computer system 102. In this embodiment, the addresses are dynamic instead of static (i.e., permanently assigned) and addresses that are no longer in use are returned to the pool for future reallocation. After a network address is assigned, the network address is transmitted to the requesting client computer system 102 in element 514, after which the flow chart terminates.

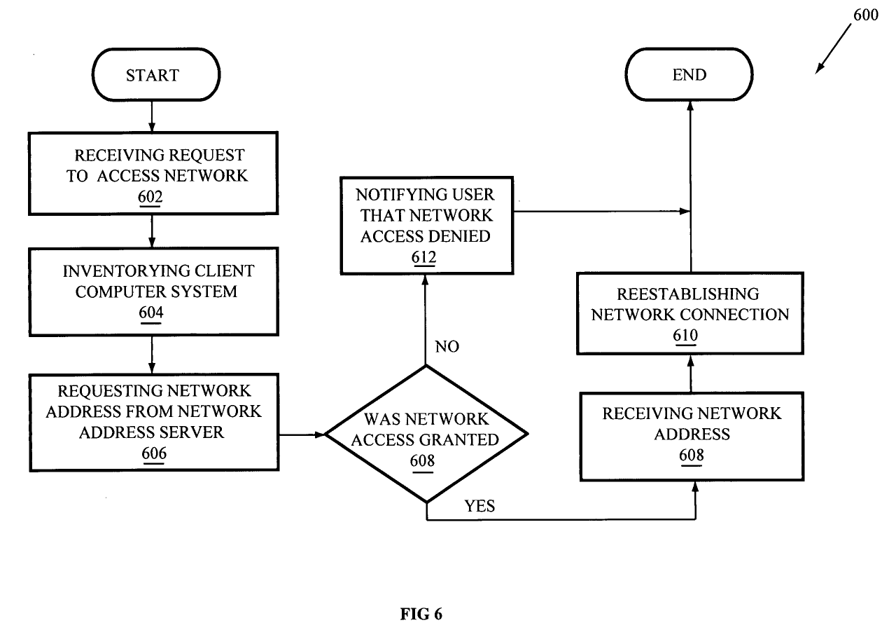

FIG. 6 depicts an example of a flow chart 600 for a client computer system 102 to gain access to network 104 according to one embodiment. The method of flow chart 600 may be performed on a client computer system 102 on which a user is attempting to gain access to network 104. Flow chart 600 begins with optional element 602, receiving request to access network. In this element, a request from a user to gain access may be received, such as from user input (via keyboard or other device). In an alternative embodiment, the request may be automatically generated, such as when the client computer system 102 first boots up or an attempt is made to connect to the network 104 (wired or wireless).

Flow chart 600 continues to optional element 604, inventorying the client computer system 102. In element 604, the contents of the client computer system 102 may be inventoried or surveyed. This allows for the status of the client computer system 102 to be established, including versions of software, files such as virus files, hardware configurations, etc. Element 604 is not needed when status information is not included in the request message.

In element 606, a network address is requested from the network address server 106. In one embodiment, the network address is requested by transmitting a request message (i.e., a DHCP message) to the network address server 106. The request message may be a simple request identifying the client computer system 102 or it may include status information about the client computer system 102. In this embodiment, status information may be stored in various fields of the request message.

Decision block 608 depends on whether network access was granted by the network address server 106, which is typically determined based on whether a network address is received or not. If network access was not granted, flow chart 600 continues to optional element 612, notifying the user that network access was denied, after which the flow chart terminates. If network access was granted, a network address is received in element 608. After the network address is received, the flow chart continues to element 610, reestablishing the network connection. The network connection may be accomplished by any means, including rebooting of the client computer system 102, automatically after receiving the address, by user selection or activation, etc. After the network connection is established again, the function terminates.

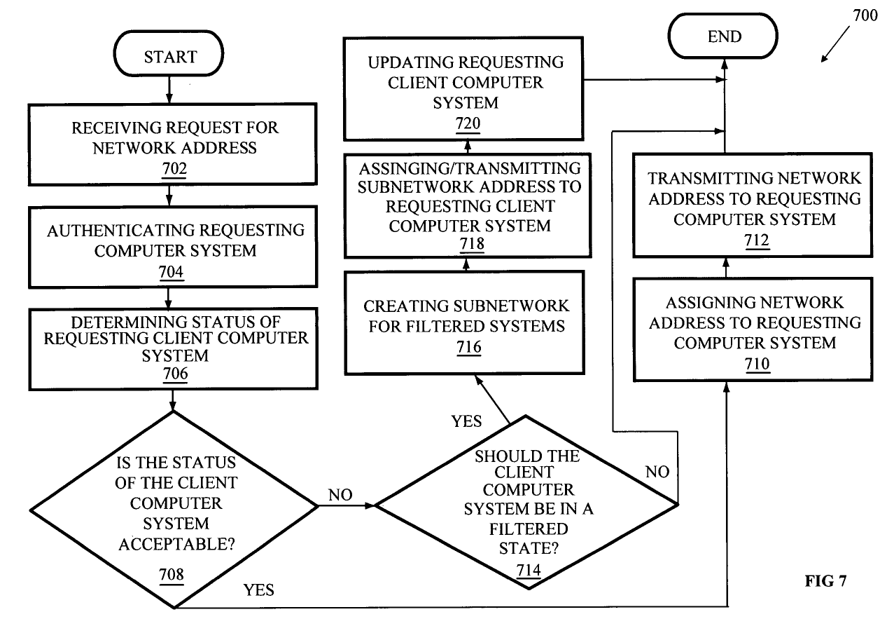

FIG. 7 depicts an example of a flow chart 700 for receiving a request for a network address and selectively providing a network address according to another embodiment. The method of flow chart 700 may be performed, in one embodiment, by the network address server 106. The method of flow chart 700 is an alternative embodiment to that of flow chart 500, and similar elements may have substantially the same function. In the interests of brevity, attention will be focused on the unique aspects of flow chart 700. Flow chart 700 begins with elements 702 and 704, which are the same as elements 502 and 504, respectively, of FIG. 5. Flow chart continues to element 706 and decision block 708, which are the same as element 508 and decision block 510, respectively. In the depicted embodiment, flow chart 700 does not contain a querying database element (such as element 506 of FIG. 5), but such an element may be utilized, particularly where the request message does not contain any status information. If the status of the requesting client computer system 102 is determined to be acceptable in decision block 708, the method continues to elements 710 and 712, where a network address is assigned and transmitted to the client computer system 102, after which the method terminates. Elements 710 and 712 are similar to elements 512 and 514 of FIG. 5 and the discussion of those elements applies here.

If the status of the requesting client computer system 102 is determined to be not acceptable for full access to network 104, flow chart 700 continues to decision block 714, determining whether the client computer system 102 should be put into a filtered state. A filtered state may be used to place a client computer system 102 on a subnetwork with lesser capabilities or access than network 104. This may be useful where the status of the client computer system 102 may be modified in order to become acceptable. For example, if the status of a client computer system indicates that the operating system is missing a recent critical patch, it may be able to be modified in order to be at an acceptable state for the network. In one embodiment, the status of the requesting client computer system 102 may be compared to minimum requirements for a filtered state for the computer system. For example, operating system updates may be considered acceptable for placing a client computer system 102 on a subnetwork as an out of date operating system presents little threat to the network, while an outdated virus file may not be considered for a subnetwork. Any type of measure of that information (e.g., comparison to a certain date or version, validity of the license, date of update, etc.) may be utilized. If it is determined that the client computer system 102 should not be placed on a subnetwork, flow chart 700 terminates.

The subnetwork may be created in optional element 716, creating a subnetwork for filtered systems. Alternatively, the subnetwork may already have been created independent of flow chart 700. The method continues to element 718, assigning and transmitting the subnetwork address associated with the subnetwork to the requesting client computer system 102 (similar to elements 710 and 712 but for a subnetwork address). A client computer system 102 may use the subnetwork address to access the network 104 in a filtered state. The method continues to optional element 720, updating the requesting client computer system 102, after which the method terminates. In one embodiment, the unacceptable aspects of the client computer system 102 may be corrected (such as by updating programs, licensing programs, etc.) while the system is on the subnetwork. This allows easy updating of client computer systems 102 without requiring a visit from a technical support person or actions by the user.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

It will be apparent to those skilled in the art having the benefit of this disclosure that the present invention contemplates methods, systems, and media for providing access to a network. It is understood that the form of the invention shown and described in the detailed description and the drawings are to be taken merely as examples. It is intended that the following claims be interpreted broadly to embrace all the variations of the example embodiments disclosed.

What is claimed is:

1. A method for providing network access, the method comprising:
receiving a request for a network address from a client computer system via a network;
determining the status of the requesting client computer system;
determining whether the status of the requesting client computer system is acceptable;
in the event that the status of the requesting client computer system is determined to be acceptable, assigning the network address to the requesting client computer system; and
transmitting the network address to the requesting client computer system.

2. The method of claim 1, further comprising authenticating the requesting client computer system.

3. The method of claim 1, wherein assigning the network address comprises assigning an IP address.

4. The method of claim 1, wherein receiving the request for a network address via a network comprises receiving the request for a network address via a LAN.

5. The method of claim 1, wherein receiving the request for a network address via a network comprises receiving the request for a network address via a wireless network.

6. The method of claim 1, wherein determining the status of the requesting client computer system includes querying a database to determine the system configuration of the requesting client computer system.

7. The method of claim 1, wherein the request for a network address comprises an indication of the identity of the requesting client computer system.

8. The method of claim 1, wherein the request for a network address includes an indication of software installed on the requesting client computer system.

9. The method of claim 1, wherein the request for a network address includes an indication of a virus file located on the requesting client computer system.

10. The method of claim 1, wherein the request for a network address is in a DHCP format.

11. The method of claim 1, wherein assigning the network address comprises assigning the network address associated with a subnetwork, the subnetwork having lesser privileges than the network.

12. The method of claim 1, further comprising updating the requesting client computer system based on the determined status of the requesting client computer system.

13. The method of claim 1, wherein the status of the requesting client computer system includes an indication of software installed on the client computer system.

14. The method of claim 1, wherein the status of the requesting client computer system includes an indication of a virus file located on the requesting client computer system.

15. A machine-accessible medium containing instructions effective, when executing in a data processing system, to cause said data processing system to perform operations comprising:
receiving a request for a network address from a client computer system via a network;
determining the status of the requesting client computer system;
determining whether the status of the requesting client computer system is acceptable;
in the event that the status of the requesting client computer system is determined to be acceptable, assigning the network address to the requesting client computer system; and
transmitting the network address to the requesting client computer system.

16. The machine-accessible medium of claim 15, wherein determining the status of the requesting client computer system comprises querying a database to determine the system configuration of the requesting client computer system.

17. The machine-accessible medium of claim 15, wherein the request for a network address includes an indication of the identity of the requesting client computer system.

18. The machine-accessible medium of claim 15, wherein the request for a network address includes an indication of software installed on the requesting client computer system.

19. The machine-accessible medium of claim 15, wherein the request for a network address includes an indication of a virus file located on the requesting client computer system.

20. The machine-accessible medium of claim 15, wherein the request for a network address is in a DHCP format.

21. The machine-accessible medium of claim 15, wherein assigning the network address comprises assigning the network address associated with a subnetwork, the subnetwork having lesser privileges than the network.

22. A data processing system for providing access to a network, the system comprising:
a communication module, the communication module being adapted to receive a request message from a client computer system via the network, wherein the communication module is further adapted to transmit a network address to the client computer system via the network;
a status determining module, the status determining module being adapted to determine the status of the client computer system, wherein the status determining module is further adapted to determine whether the status of the client computer system is acceptable; and
a network address module, the network address module being adapted to select the network address for a client computer system that is determined to have an acceptable status by the status determining module.

23. The system of claim 22, further comprising an authentication module, the authenticating module being adapted to authenticate the client computer system based on the request message received by the communication module.

24. The system of claim 22, further comprising an update module, the update module being adapted to update the client computer system via the network in the event that the status of the client computer system is determined to be unacceptable.

25. The system of claim 22, wherein the network address module is adapted to select an IP address for the network address.

26. The system of claim 22, wherein the communications module is adapted to receive the request for a network address in a DHCP format.

27. The system of claim 22, wherein the communications module is adapted to receive the request for a network address including an indication of the identity of the client computer system.

28. The system of claim 22, wherein the communications module is adapted to receive the request for a network address including an indication of software installed on the client computer system.
